(19) United States
(12) Patent Application Publication
(10) Pub. No.: US 2011/0107703 A1
(43) Pub. Date: May 12, 2011

(54) DOOR AND METHOD OF MANUFACTURING THEREOF

(76) Inventor: William Mullet, Sugarcreek, OH (US)

(21) Appl. No.: 12/614,674

(22) Filed: Nov. 9, 2009

(51) Int. Cl. E06B 3/72; E04C 2/38

(52) U.S. Cl. 52/455; 52/656.4; 52/745.15

(57) ABSTRACT

A door including a frame having a plurality of slots on opposing sides, a pair of skins having a plurality of protrusions extending from a back surface, wherein the skin is secured to the frame with an adhesive between the skin and the frame as well as between the protrusions and slots. A method of manufacturing a door including the steps of forming a plurality of slots in a frame, forming a plurality of protrusions on a back side of a first skin, applying a layer of adhesive on at least one of the frame and the skin, and inserting the plurality of protrusions into the plurality of slots.

### BACKGROUND OF THE INVENTION

1. Technical Field

The invention relates generally to hinged door assemblies which are mounted in an entry way. More particularly, the invention relates to a door assembly having skins secured to a frame. Specifically, the invention relates to a door assembly with a plurality of skins secured to a frame with protrusions, in a variety of skin arrangements, and a method of manufacturing the door.

2. Background Information

Doors are movable barriers used to cover an opening. A traditional household door can come in a variety of shapes and sizes depending on the desired look. However, the inner and outer skin of a door share the same profile, meaning that the design on the outside is the same as the design on the inside.

A traditional hinged door is secured on one side to a door frame opening with hinges and secured to the other side with a locking mechanism. The frame may be comprised of four pieces, including a top and bottom rail secured between a hinge stile and a lock stile. The connection points of the frame may have dovetail joints machined in them so that the frame is a sturdy assembly. Skins are then secured to each face of the door frame assembly with an internal core separating these skins. The skins may be composed of fiberglass, wood, or any other suitable material, while the core may also be solid wood or a spray foam composite material. Traditionally, the back side of each skin is flush and adapted to receive an adhesive to secure the skin to the frame assembly. In order to assemble the door, the frame is assembled and one of the skins is secured to one side of the frame. Next, a foam core is inserted between the frame assembly and against the installed skin. Finally, the opposing skin is then glued to the open side of the door frame.

### BRIEF SUMMARY OF THE INVENTION

The present invention broadly comprises a door including a frame having a plurality of slots, a first skin having a plurality of protrusions extending from a first skin back side, a second skin having a plurality of protrusions extending from a second skin back side, an adhesive disposed intermediate the frame and the first skin back side, and an adhesive disposed intermediate the frame and the second skin back side.

The present invention also broadly comprises a door including a frame having a plurality of protrusions on a first side and a second side, a first skin and a second skin each having a back side with a plurality of slots, an adhesive disposed intermediate the first side and the first skin back side, an adhesive disposed intermediate the second side and the second skin back side, and wherein the first skin plurality of slots receive the first side plurality of protrusions and the second skin plurality of slots receive the second side plurality of protrusions.

The present invention further broadly comprises a method of manufacturing a door including the steps of forming a plurality of slots in a frame, forming a plurality of protrusions on a back side of a first skin, applying a layer of adhesive on at least one of the frame and the skin, and inserting the plurality of protrusions into the plurality of slots.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front elevational view of the door assembly with a first skin mounted thereon;

FIG. 2 is an exploded view of a preferred embodiment door assembly with the skins rotated in order to view the inside surface of each skin;

FIG. 3 is a top plan view of the lock stile disconnected from the bottom and top rails;

FIG. 4 is a front view of the lock stile showing vertical slots therein;

FIG. 5 is a top plan view of the hinge lock stile disconnected from the top and bottom rails;

FIG. 6 is a front view of the lock stile with vertical slots therein;

FIG. 7 is a bottom view of a bottom rail with horizontal slots therein;

FIG. 8 is a perspective view of a portion of the back side of a skin with a plurality of vertical protrusions extending from the back side of the skin;

FIG. 9 is a front view of a portion of the top rail being slid downward and installed on the lock stile dovetail connection;

FIG. 10 is a top view of a portion of the top rail secured to the lock stile with an adhesive;

FIG. 11 is a top view of a preferred embodiment door assembly taken generally about line 11-11 in FIG. 9 with the door skins removed;

FIG. 12 is an assembled view of a preferred embodiment door assembly illustrated in FIG. 11 with the door skins attached to the frame;

FIG. 13 is an enlarged view of the section labeled FIG. 13 in FIG. 12;

FIG. 14 is a perspective view of the top stile side of a preferred embodiment door in the fully assembled state;

FIG. 15 is an exploded view of a second preferred embodiment door frame assembly with the skins rotated to show the door skin inner surfaces and a dual composite wood frame;

FIG. 16 is a top cross-sectional view of a second preferred embodiment door with a dual composite frame;

FIG. 17 is an exploded view of a third preferred embodiment door assembly with the skins rotated to show the inner surfaces of each skin;

FIG. 18 is a cross-sectional view of a third preferred embodiment door frame assembly with door skins separated from the frame; and,

FIG. 19 is a cross-sectional view of the door assembly in FIG. 18 with the skins attached.

Similar numbers refer to similar parts throughout the drawings.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed aspects.

Unless defined otherwise, all technical and scientific terms used herein have the same meaning as commonly understood to one of the ordinary skill in the art to which this invention belongs. Although any methods, devices or materials similar or equivalent to those described herein can be used in the practice or testing of the invention, the preferred methods, devices, and materials are now described.

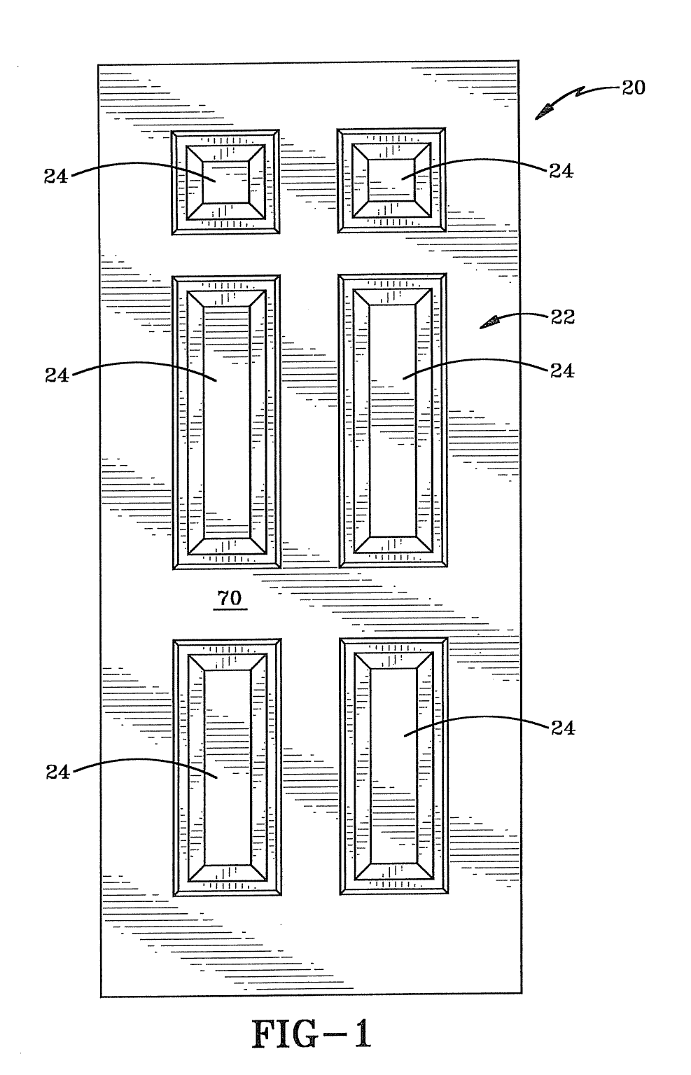

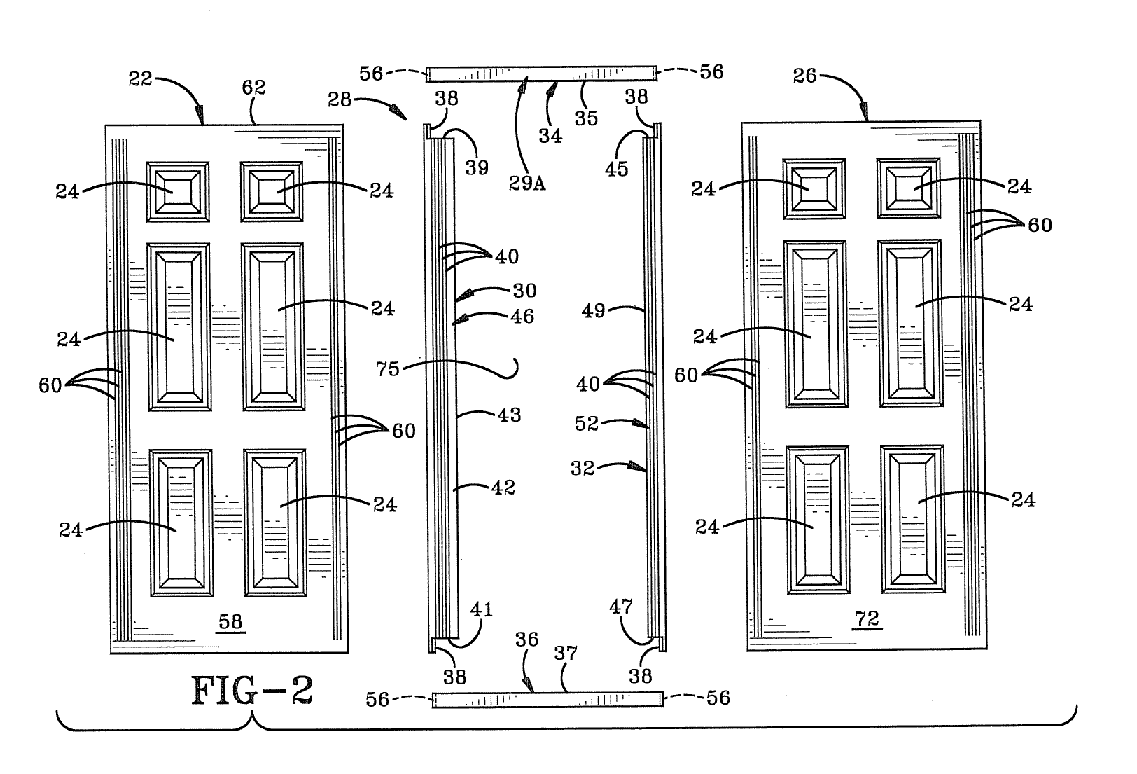

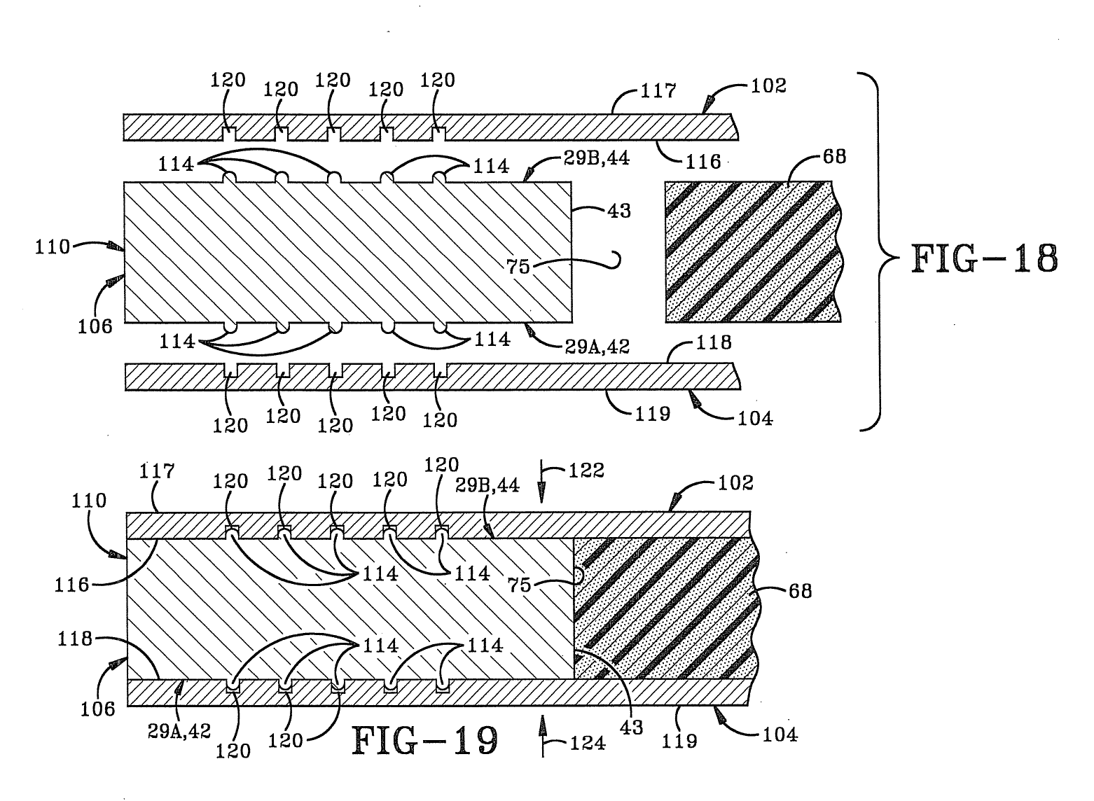

The door assembly of the present invention is indicated generally at 20, and is particularly shown in FIGS. 1-19. As specifically seen in FIG. 1, a preferred embodiment door assembly 20 includes a first skin 22 with a variety of panels 24. As seen in FIG. 2, door assembly 20 also includes a second skin 26 which is secured to the door frame 28 opposite first skin 22 and will be described in further detail below.

Door frame 28 includes four components in a preferred embodiment. A lock stile 30 is parallel and spaced apart from a hinge stile 32. The hinge and lock stiles define the vertical perimeter of the door and are preferably spaced apart approximately the same distance as the length of a top rail 34 and a bottom rail 36. Lock stile 30 includes dovetail joints 38 extending from a top end 39 and a bottom end 41 to ensure a secure engagement with the top and bottom rails. Hinge stile 32 also includes dovetail joints 38 extending from a top end 45 and a bottom end 47.

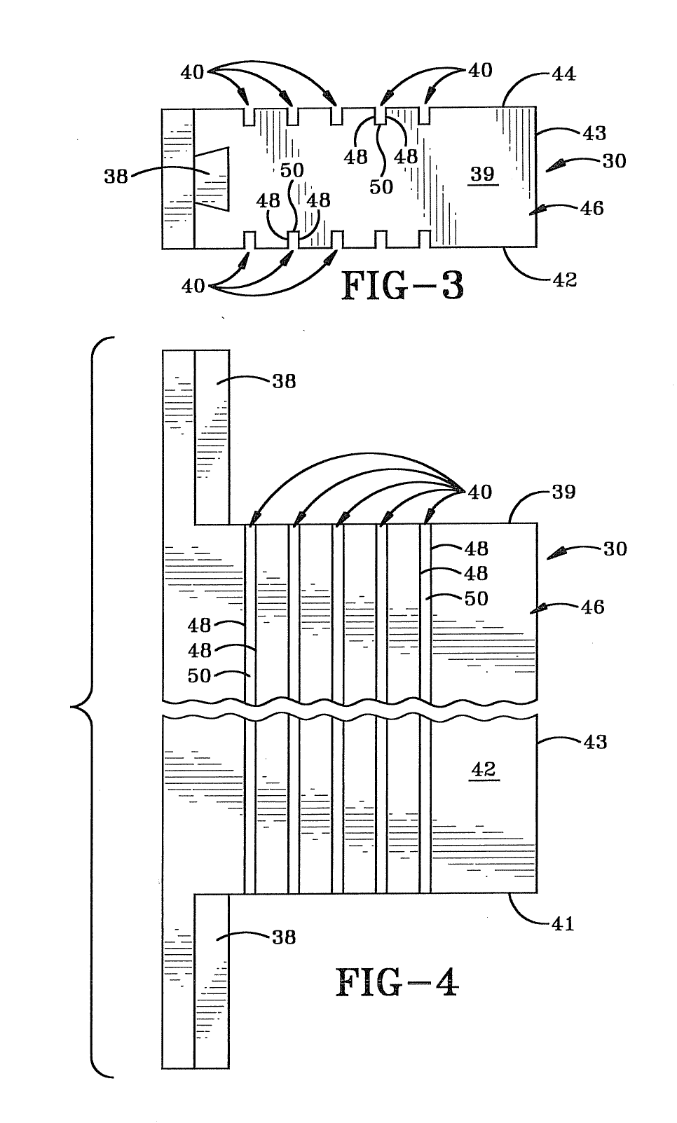

In accordance with one of the main features of the present invention, a plurality of slots 40 is formed in both a front side 42 and a back side 44 of lock stile body 46. In a preferred embodiment, slots 40 are formed in body 46 and extend vertically the full length of body 46, however, it is within the spirit in the scope of the present invention as claimed that the slots extend for merely 25% of the height of the frame, 50% of the height of the frame, or any other suitable length. As seen in FIGS. 3 and 4, slots 40 include sidewalls 48 and a bottom wall 50 which define a generally rectangular opening. While the protrusion is preferably defined with a rectangular cross-section, any suitable cross-section may be incorporated, including semi-circular, square or any other shape.

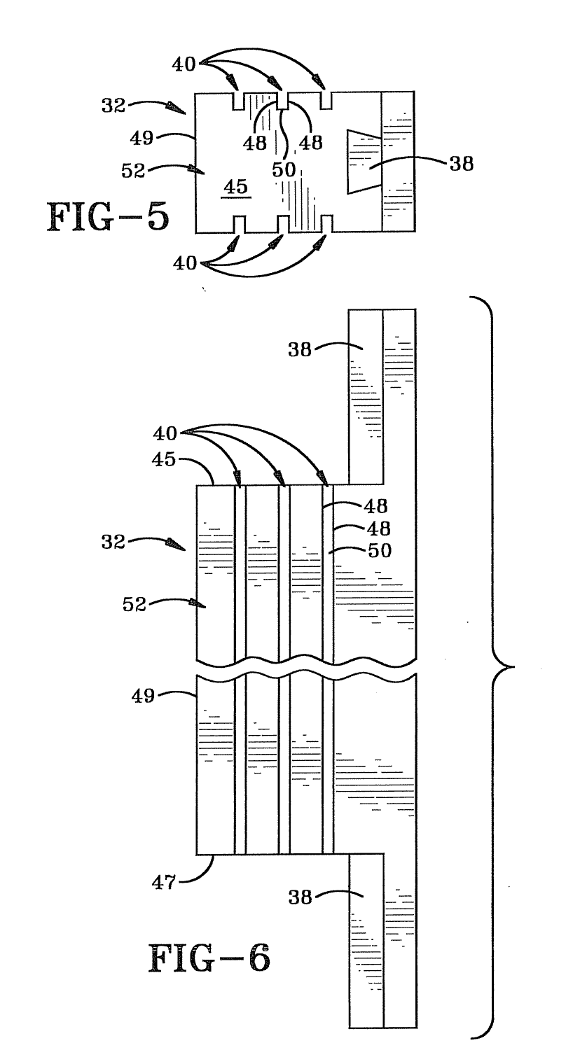

Moving on to FIGS. 5 and 6 and in accordance with yet another main feature of the present invention, hinge stile 32 is arranged similar to lock stile 30. Hinge stile 32 includes a plurality of slots 40 arranged vertically throughout the length of body 52 of hinge stile 32.

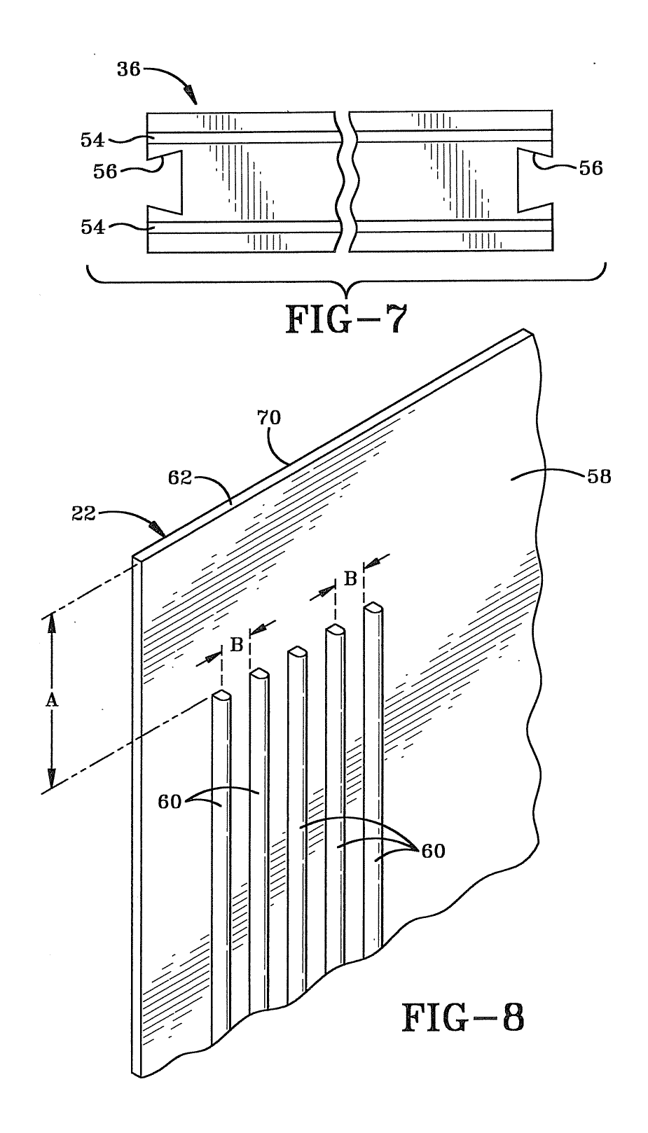

FIG. 7 is a bottom view of bottom rail 36. Bottom rail 36 includes a pair of bottom slots 54 extending along the length of bottom rail 36. Bottom slots 54 are preferably arranged to receive a door sill seal. Further, bottom rail 36 includes receiving portions 56 which are complimentary shaped to and arranged to contact the dovetail joint of the hinge and lock stiles.

Referring to FIGS. 2 through 6, lock stile body 46 includes an inner wall 43 and hinge stile body 52 includes an inner wall 49. Further, top rail 34 and bottom rail 36 each include inner walls 35 and 37 respectively. Advantageously, inner walls 35, 37, 43 and 49 define an internal cavity 75.

In accordance with yet another main feature of the present invention, FIG. 8 illustrates first skin 22 with a back side 58 having a plurality of protrusions 60 extending therefrom. In a preferred embodiment, protrusions 60 are spaced a distance A from a top edge 62 of skin 22. Further, a similar distance is incorporated for the bottom end of the skin (not shown). Advantageously, this arrangement allows the second skin back side 58 to be flush against top rail 34 and bottom rail 36 while allowing protrusion 60 to engage slots 40. While a preferred embodiment second skin includes five protrusions, any number or arrangement of protrusions may be incorporated without departing from the spirit and scope of the present invention as claimed. Further, protrusions 60 are illustrated with generally square walls extending from the back side of the skin and a rounded top end. Protrusion 60 may have a varying width as well as any suitable shape so long as they mate with slots 40. Finally, protrusions 60 are also spaced apart a distance B which can also be varied so long as the requirements above are satisfied.

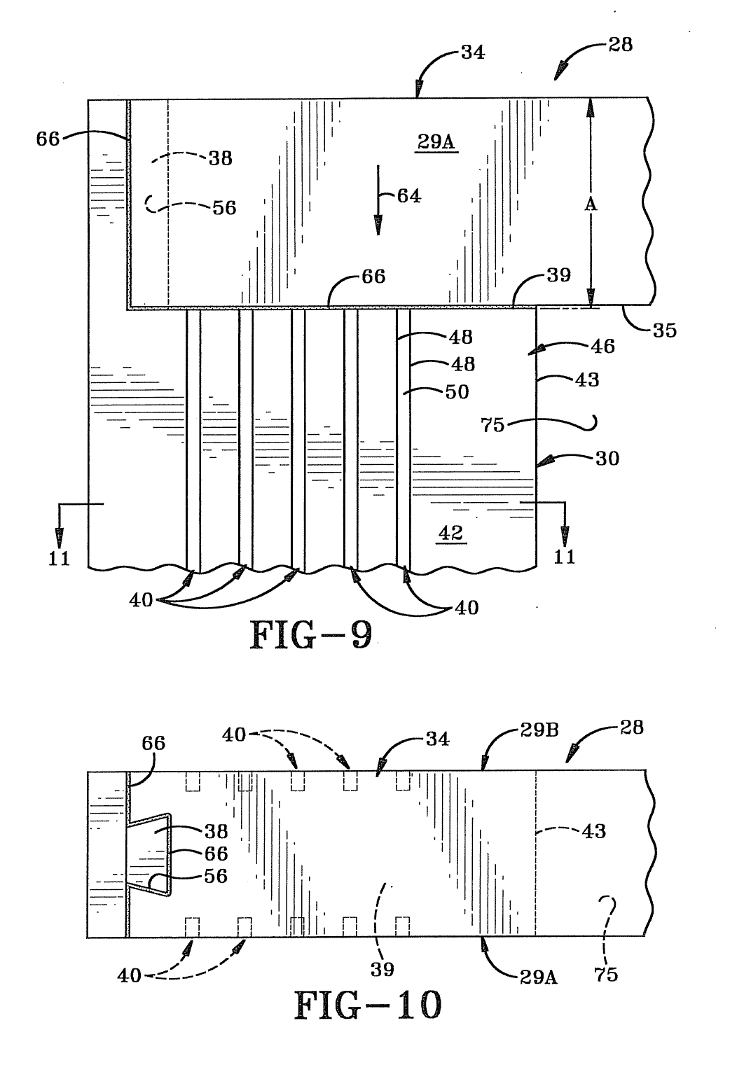

FIG. 9 illustrates top rail 34 being inserted in the direction of arrow 64 to install the top rail on frame 28 along top end 39. An adhesive 66 is placed on inner wall 35 and receiving portion 56 to secure the top rail to lock stile 30. A similar process is completed with respect to hinge stile 32 to secure the other side of top rails 34 to the hinge stile. While the adhesive is described as being placed on inner wall 35, the adhesive may also be placed directly on the hinge and lock stiles.

FIG. 10 is a top view of top rail 34 installed on dovetail joint 38 of lock stile 30. In particular, dovetail joint 38 is slidingly engaged with receiving portion 56 of top rail 34. Advantageously, this arrangement allows top rail 34 to be secured on lock stile 30 and permit movement only in an upward direction.

FIGS. 11-13 illustrate the attachment of first skin 22 and second skin 26 to lock stile 30 as well as locating a foam core 68 between the skins in cavity 75. FIG. 11 illustrates skins 22 and 26 prepared for installation on lock stile 30, while a similar arrangement is found at hinge stile 32, but not shown. As discussed above, skin 22 includes a back side 58 with protrusions 60 extending away from the skin. The first skin 22 also has a front side 70 which includes a variety of panels as discussed above. Second skin 26 includes a back side 72 having a plurality of protrusions 60 extending therefrom and a front side 74 opposite back side 72 and also including a plurality of panels.

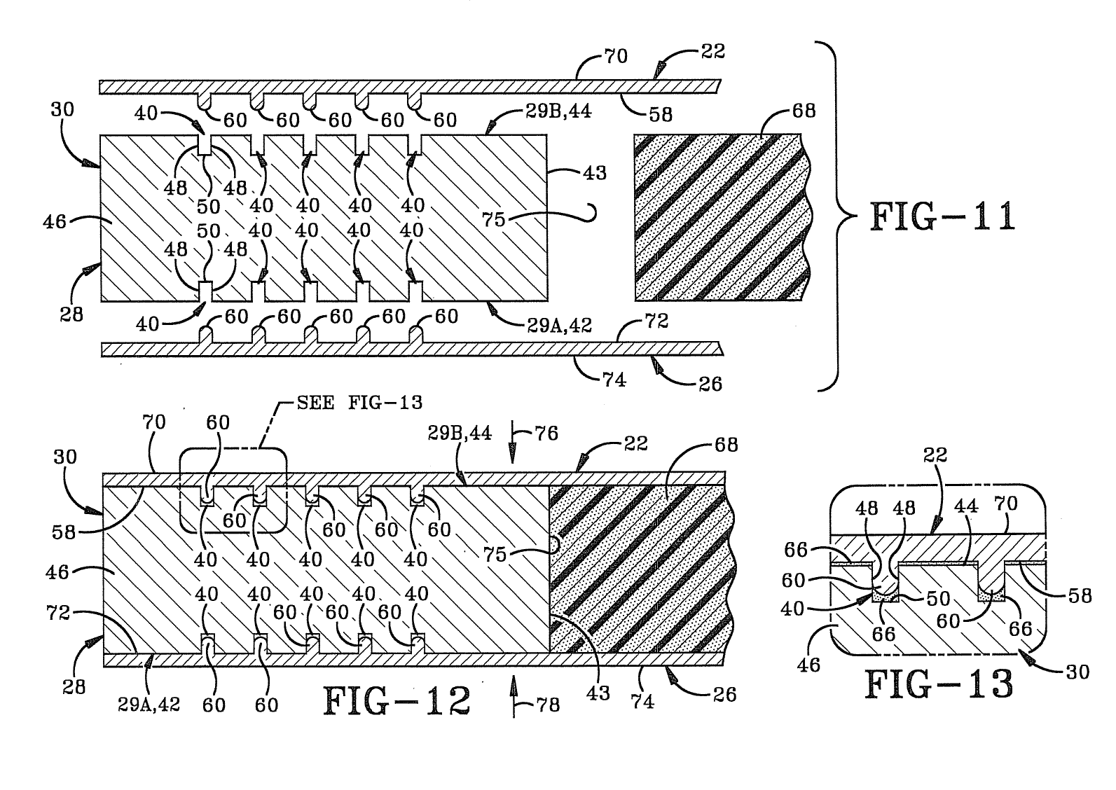

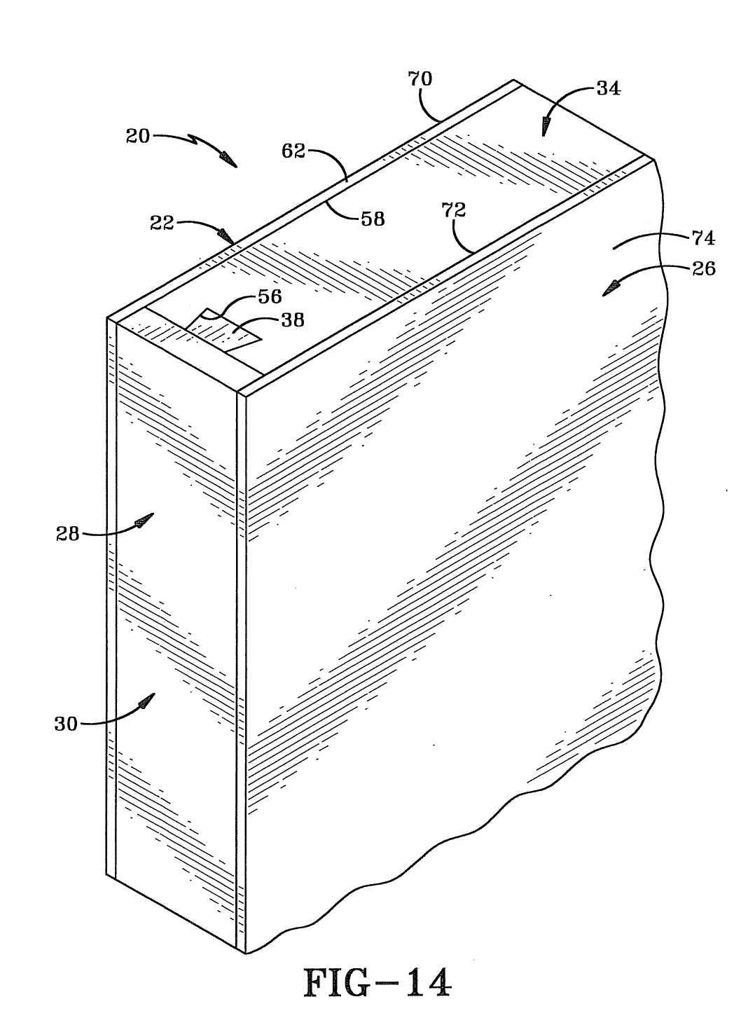

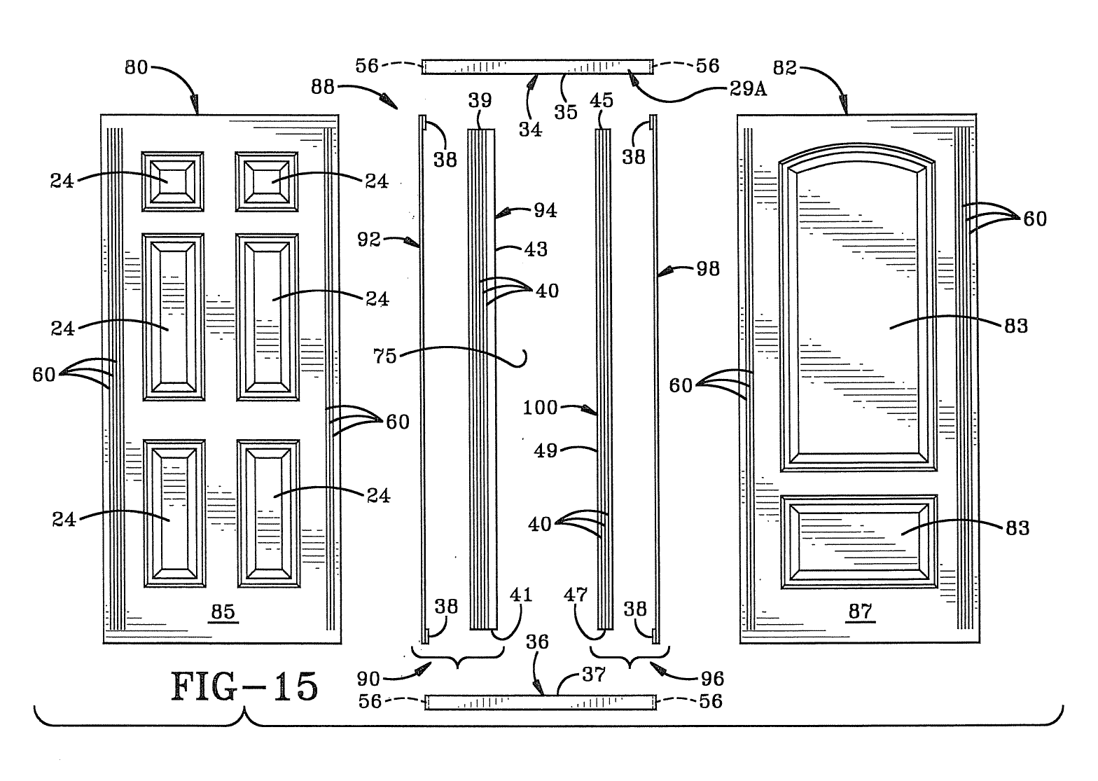

FIG. 12 illustrates first skin 22 and second skin 26 in the installed position after forcing protrusions 60 within slots 40. Specifically, skin 22 is forced in the direction associated with arrow 76 while skin 26 is forced in the direction associated with arrow 78. In a preferred embodiment and seen in FIGS. 12 and 13, adhesive is located along the back side 58 of skin 22 and back side 72 of skin 26 such that adhesive bonds between the back sides 58, 72 and lock stile 30 and a top rail outer surfaces 29A and 29B. Further adhesive is also located within slots 40 and on protrusions 60 such that there is an increased adhesive area at the protrusions. During the installation, skins 22 and 26 are forced in their respective directions until protrusions 60 are fully seated within slots 40. Protrusions 60 and slots 40 may also be arranged such that there is a slight interference fit to ensure that the skins do not become separated from the frame while the adhesive is curing.

FIG. 14 illustrates the top corner of a preferred embodiment door assembly 20. Top rail 34 is adhesively secured to lock stile 30, while skins 22 and 26 are each adhesively secured to top rail 34 and lock stile 30. Accordingly, the present invention creates a sounder and more secure bound between door skins 22 and 26 and lock stile 30 and hinge stile 32 (not shown) while retaining the traditional look of a standard door.

Having described the structure of the first embodiment, only those portions of the second embodiment which are different than the first embodiment are described in detail. Likewise, similar numerals refer to similar parts throughout the various embodiments.

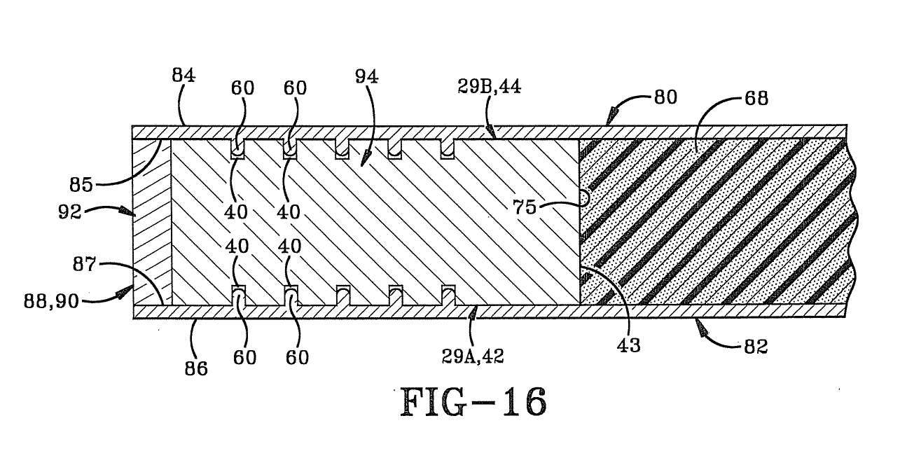

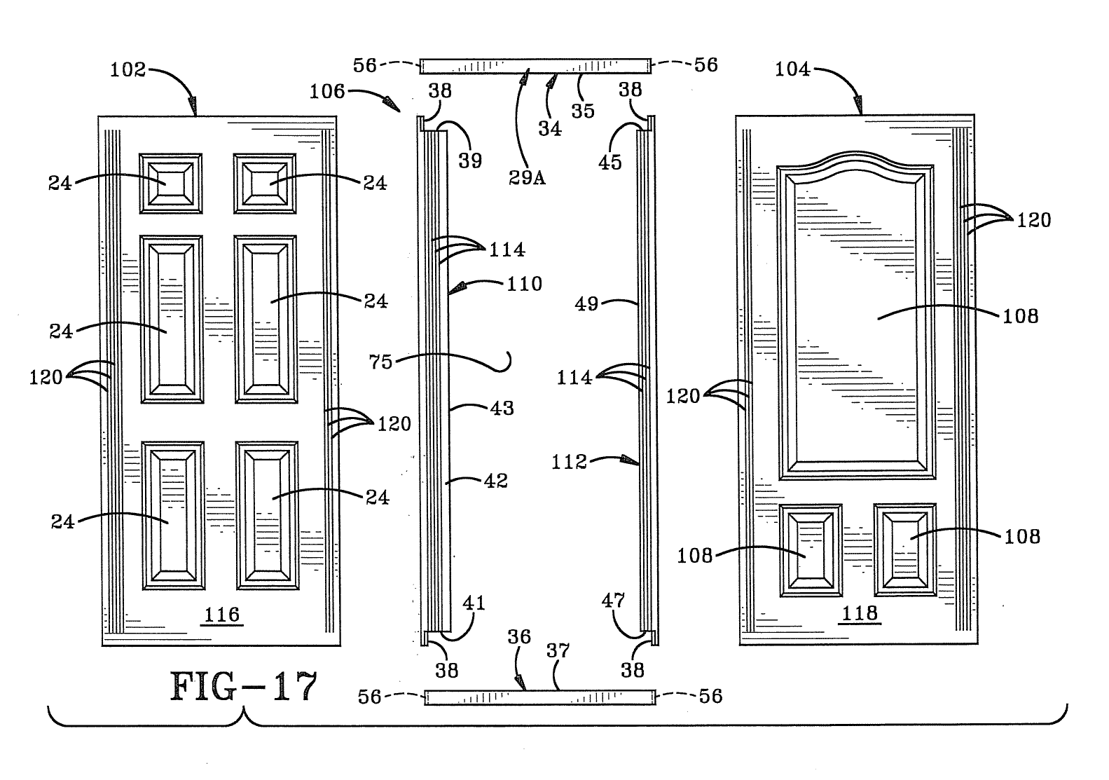

FIGS. 15 and 16 illustrate a second preferred embodiment, with a first skin 80 and a second skin 82. In accordance with yet another main feature of the present invention, skins 80 and 82 have distinct and different outer surfaces 84 and 86 respectively. Further, inner surfaces 85 and 87 of skins 80 and 82 are also distinct from each other. While the second preferred embodiment is shown with six panels 24 on the first skin and two panels 83 on the second skin, any arrangement of first and second skins that have a distinct outer appearance may be utilized. Advantageously, this allows the purchaser to have a first skin which matches the exterior of the dwelling, while having a second skin facing the interior of the dwelling that again matches a completely different environment than the outside.

Another advantage of the preferred embodiments is the ability to selectively size the door using protrusions 60 and slots 40. Specifically, protrusions 60 may align with only a portion of slots 40, thereby having a portion of the skins hang over the frame. The skin can then be trimmed to reduce the side of the door. The hinge and lock stiles may then include an additional member bolted thereon to ensure a proper door size.

In a second preferred embodiment, frame 88 is composed of six pieces, top rail 34 and bottom rail 36 remaining the same as the previous embodiment. However, lock stile 90 includes a high quality outer piece 92 and a low quality interior piece 94. Hinge stile 96 also includes a high quality outer piece 98 and a low quality inner piece 100. High quality pieces 92 and 98 both include dovetail joints at the top and bottom portions and define the outer most edges of the frame. High quality pieces 92 and 98 are also thin and incorporated at the ends to provide the appearance of a hard wood or high quality door throughout the frame construction, while reducing costs by incorporating low quality pieces 94 and 100. Further, low quality pieces 94 and 100 include protrusions 40 similar to the first embodiment throughout their length. Advantageously, incorporating low quality pieces 94 and 100 for the entire length of the slots ensures that machining of the slots is more readily accomplished without a waste of material.

Finally, high quality piece 92 is preferably adhesive secured to low quality piece 94, while high quality piece 98 is also adhesively secured to low quality piece 100. Accordingly, when the high quality and low quality pieces are attached, they form the lock stile and hinge stile described in the first preferred embodiment in a more cost effective manner.

Having described the structure of the first two embodiments, only those portions of the third embodiment, which are different than the first two embodiments, are described in detail. Likewise, similar numerals refer to similar parts throughout the various embodiments.

FIGS. 17-19 illustrate a third preferred embodiment with a first skin 102, a second skin 104, and a frame 106. Frame 106 is generally shaped identical to the first preferred embodiment frame, however the incorporation of the second preferred embodiment frame with high quality and low quality pieces is within the spirit and the scope of present invention as claimed. Further, first skin 102 is arranged similar to first skin 22 in that there are six panels 24. Second skin 104 has three panels 108 in the third preferred embodiment to provide a distinct and different appearance than the first skin. Frame 106 includes a lock stile 110 and a hinge stile 112.

In accordance with one of the main features of the present invention, lock stile 110 and hinge stile 112 (not shown) include a plurality of protrusions 114 extending from both sides of each stile. Further, skins 102 and 104 each include a back side 116 and 118 respectively. A plurality of slots 120 are formed within back sides 116 and 118 so that slots 120 are arranged to receive protrusions 112 of lock stile 110 and hinge stile 112.

As discussed in the first preferred embodiment, installation of the third preferred embodiment skins is similar in that first skin 104 is forced in the direction associated with arrow 122 until protrusions 114 are inserted within slots 120, while the second skin is forced in the direction associated with arrow 124 until protrusions 114 are inserted within slots 120. Once again, this arrangement provides for an increased adhesion contact area as well as an interference fit between the skins and the stiles.

Having described the structure of the preferred embodiments, a preferred method of manufacturing will be described in detail and should be read in light of FIGS. 1-19.

Initially, plurality of slots 40 are formed in frame 28, and preferably in lock stile 30 and hinge stile 32. Next, a plurality of protrusions 40 are formed on back side 58 and 72 of the skins. The slots may be formed by machining or any other suitable removable technique. Similarly, protrusions 60 may be formed by removing material with a machining apparatus or by adhesively securing preformed protrusions on the back side of each skin. Alternatively, slots 40 may be formed in the skins, while protrusions 60 may be formed on frame 28 without departing from the spirit of the invention.

Next, adhesive is located on either frame 28 or back side 58 and 72 of skins 22 and 26. The skins are then directed towards the frame such that the protrusions 60 are inserted within the respective slots 40 of the frame. After one side has been inserted, foam core 68 is disposed within the frame or may be placed by blowing foam insulation within the frame.

Frame assembly 28 is formed by machining top rail 34 with receiving portions 56 on each end and bottom rail 36 with the same receiving portions 56. Lock stile 30 and hinge stile 32 each include dovetail joints 38 on each end. The dovetail joints and receiving protrusions are complimentary shaped to ensure a tight and secure fit as well as provide increased contact surface for the adhesive to cure. Frame 28 is finally formed by securing the dovetail joints and receiving portions of the lock stile, hinge stile, top rail and bottom rail with adhesive.

While the above method of manufacturing utilizes protrusions on the back side of each skin, it is within the spirit of the scope of the present invention to form protrusions on both sides of the lock and hinge stiles and machine slots in the back side of each skin. Further, a combination of the two may also be used without departing from the spirit of the scope of the invention as claimed. For example, one side of the lock stile may have protrusions, while the opposite side of the same stile may have slots therein. Still further, the lock stile may have protrusions on both ends, and a combination of protrusions and slots while the hinge stile only has slots. Thus, it is seen that any useful combination of slots and protrusions on the stiles and skins may be used without departing from the spirit and scope of the present invention as claimed.

Thus, door assembly 20 provides an increased contact surface area between a door frame and the skins. The door skins are also arranged so that a first skin may have a unique and distinct outward appearance, while the opposing second skin may have a completely different appearance to enable the purchaser to custom fit his/her desired application. Further, a cheaper and more cost effective version of the invention may be incorporated by providing both high quality and low quality wood strategically placed to provide the increased contact surface as well as different skin options.

It will be evident to one skilled in the art that a variety of changes can be made that are within the spirit and scope of the present invention. For instance, the protrusions may be located on either the skin or the stile, while the slots may also be located on either the skin or stiles. Further, any suitable skin design may be used in combination with any other suitable skin design such that the purchaser has a great deal of flexibility in his/her door skins.

Accordingly, the door assembly is an effective, safe, inexpensive, and efficient device that achieves all of the desired objectives of the invention, provides for eliminating difficulties encountered with prior art devices, systems, methods, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is an example, and the scope of the invention is not limited to the exact details shown or described.

Having now described the features, discoveries, and principles of the invention, the manner in which the door frame is constructed and used, the characteristics of the construction, and the advantageous new and useful results obtained; the new and useful structures, devices, elements, arrangement, parts and combinations are set forth in the appended claims.

1. A door comprising:
a frame having a plurality of slots;
a first skin having a plurality of protrusions extending from a first skin back side;
a second skin having a plurality of protrusions extending from a second skin back side;
an adhesive disposed intermediate the frame and the first skin back side, and,
an adhesive disposed intermediate the frame and the second skin back side.

2. The door of claim 1 wherein the first skin comprises a first design and the second skin comprises a second design wherein the first design is different than the second design.

3. The door of claim 1 wherein the first skin comprises three panels and the second skin comprises six panels.

4. The door of claim 1 wherein the plurality of slots are arranged vertically and extend for more than twenty-five percent of a height of the frame.

5. The door of claim 1 wherein the plurality of slots extend for more than fifty percent of a height of the frame.

6. The door of claim 1 wherein the first skin is composed of a different material than the second skin.

7. The door of claim 1 wherein the plurality of slots have a varying width.

8. The door of claim 1 wherein the frame further comprises a top rail, a bottom rail, a hinge stile and a lock stile.

9. The door of claim 8 wherein the top rail is secured to the hinge stile and lock stile with a first and a second dovetail joint, and the bottom rail is secured to the hinge and lock stile with a third and a fourth dovetail joint.

10. The door of claim 8 wherein the first skin comprises a first design and the second skin comprises a second design wherein the first design is different than the second design.

11. The door of claim 1 wherein the plurality of slots and the plurality of protrusions define an increased surface contact area.

12. The door of claim 1 wherein the plurality of slots and the plurality of protrusions define a plurality of adhesive pockets.

13. The door of claim 8 wherein:
the lock stile and the hinge stile each further comprise an inner member composed of a low quality wood, and
an outer member composed of a high quality wood.

14. A door comprising:
a frame having a plurality of protrusions on a first side and a second side;
a first skin and a second skin each having a back side with a plurality of slots;
an adhesive disposed intermediate the first side and the first skin back side;
an adhesive disposed intermediate the second side and the second skin back side; and,
wherein the first skin plurality of slots receive the first side plurality of protrusions and the second skin plurality of slots receive the second side plurality of protrusions.

15. A method of manufacturing a door comprising the steps of:
forming a plurality of slots in a frame;
forming a plurality of protrusions on a back side of a first skin;
applying a layer of adhesive on at least one of the frame and the skin; and,
inserting the plurality of protrusions into the plurality of slots.

16. The method of claim 15 wherein the step of forming plurality of slots in a frame further comprises the steps of connecting a top rail and a bottom rail to a hinge stile and a lock stile with an adhesive.

17. The method of claim 16 wherein the step of connecting includes the step of forming a dove tail connection in the top rail, the bottom rail, the lock stile and the hinge stile.

18. The method of claim 16 wherein the step of forming further comprises the step of adhering a plurality of protrusions to the back side of the first skin.

19. The method of claim 15 further comprising the step of inserting a foam core within the frame.

20. The method of claim 19 wherein the step of inserting a foam core comprises the step of blowing foam insulation within the frame.
